(19) United States
(12) Patent Application Publication
(10) Pub. No.: US 2017/0097113 A1
(43) Pub. Date: Apr. 6, 2017

(54) Leakproof Connecting device for a fluid circuit

(71) Applicant: Schrader SAS, Pontarlier (FR)

(72) Inventors: Benoit Gresset, Arbois (FR); Sébastien Robert, Besancon (FR)

(21) Appl. No.: 15/286,230

(22) Filed: Oct. 5, 2016

(30) Foreign Application Priority Data
Oct. 6, 2015 (FR) 1559489

(51) Int. Cl. F16L 23/032; F25B 41/00; F16L 41/08; F16L 23/026; F16L 13/10

(52) U.S. Cl. CPC F16L 23/032; F16L 23/026; F16L 13/103; F16L 41/084; F25B 41/003; F25B 2500/221

(57) ABSTRACT

A device for a leakproof air-conditioning fluid circuit. A body includes a conduit having a foot at its base, coupled to a communication orifice in the periphery of a tube. A welding is made between an interior part of the base of the foot and a corresponding part of a tube having an orifice. An internal semi-cylindrical a portion of the base of the foot features, around the discharging conduit, a part in the shape of a skirt, formed by two straight or curved segments which together define a semi-cylindrical cradle in the interior wall of the tube. An orifice comprising a whistle-shaped notch in the back of the tube, comprises two complementary segments.

### TECHNICAL FIELD

The present invention concerns a method used to connect a tube with a fluid device connected in a non-concentric manner and intended specifically for an air-conditioning line. This device is of a type made as a body that is crossed axially by a conduit whose head or front end is intended to accommodate a connection, and whose foot, which is the outlet of the conduit, is affixed, by its base, non-concentrically to a tube, facing a communication orifice of the latter, through a method of assembly that straddles between the base of the foot of the device, which exhibits a semi-cylindrical curved surface into which the conduit discharges, and the corresponding surface of the tube.

### BACKGROUND

These types of fits between tube and fluid devices, which are also known as devices with a “half-moon” connection, are generally made of metal and attached by brazing to get increased rigidity of the device-tube assembly. In this way, it is possible to use tubes that are also made of metal, with a wall that is thinner and tubes with smaller diameters.

However, these “half-moon” devices do not include any means of longitudinal or angular positioning. This makes it difficult to position them facing a drilled hole in the tube that is covered by the device and causes imperfect brazing, which could lead to leakage.

To remedy this drawback, it is usual to braze the device, and then drill the tube. This practice poses two problems. While drilling is taking place, when the body of the device is perforated, there is a risk of damaging the leakproof seat of the mechanism and also of leaving chips inside the line. Leaks and chips are the two main technological difficulties for manufacturers of fluid lines.

Occasionally the device is threaded into a piece which itself is introduced into the hole in the tube. This practice is difficult to implement.

The claimant has already proposed a solution that is intended to remedy the abovementioned drawbacks by describing, in his application for French patent No 1355176, a device of the abovementioned type, where the foot of this device consists, at the top of the internal semi-cylindrical part that forms its base, a centering socket that is located in the axis of the conduit of the device, and is connected to it, and is intended to be introduced into the orifice of the tube, with a diameter that is identical to within a very close clearance, according to a predetermined depth, with the internal periphery of the orifice then being lodged between the outer periphery of the socket and the bottom of the semi-cylindrical base of the foot of the device, and therefore isolated from the free end of the latter's conduit, so that this bottom area can accommodate the brazing, in a manner that is precise and without risk of obstructing the conduit.

For reasons of economy, methods have been sought to adapt it for making parts by molding, in particular of plastic material, while retaining the same advantages, or even improving the product.

### SUMMARY

Material molding techniques used, in particular for plastic, make it possible to make shapes that are difficult to obtain by machining when a metal is used, and make it possible to connect the device to the tube, avoiding all restrictions to the cross-section of the passage of this latter, and also making it possible to avoid all risk of internal contamination due to particles of material or droplets resulting from the brazing or welding processes in general, even when plastic materials are used.

The purpose of the present invention is to implement this solution that makes it possible to solve the abovementioned drawbacks.

To this end, it concerns a fluid device of the abovementioned type, distinguished by the interior semi-cylindrical part that forms the base of the foot of the device that presents, in relief, around the discharging conduit, a piece in the shape of a skirt that acts as a male part that is intended to ensure the rotational and translational positioning of the fluid device, formed by two straight or curved segments that trace out an angle at the sharp crest and which is oriented along the longitudinal axis of the semi-cylindrical base and which together define, along the transverse axis of the base, a semi-cylindrical cradle with a radius that is at most equal to the radius of the inside wall of the tube in the area of its orifice, with this latter being formed by a whistle-shaped notch made in the back of the tube, so that it forms a female part that comprises, in a manner similar to the male part of the fluid device, two complementary segments that trace an angle at the sharp crest, which is identical to and oriented along the longitudinal axis of the tube.

This manner of positioning is advantageously completed by the enclosure, past the point of the median axis of the “saddle” on the tube, thus ensuring that it is temporarily held in place before the fluid device is welded onto the tube.

The device according to the invention is intended, in particular, for a leakproof air-conditioning fluid circuit, of the type formed by a body of injectable material and a tube, with the body being axially crossed by a conduit whose head or front end acts as a connecting port, and whose foot, into which the conduit discharges, is attached by its base, which is largely perpendicular to axis (XX′) of the conduit, is placed facing a communication orifice which is made in the periphery of the tube made of injected or extruded material, by welding or gluing done between, on the one hand, an inside part of the base of the foot of the device having a semi-cylindrical curved surface into which the conduit discharges and, on the other hand, a corresponding part of the tube located in the area of its orifice, distinguished by the fact that the internal semi-cylindrical part that forms the base of the foot of the device has, in relief, around the discharging conduit, a part in the shape of a skirt that forms a male part that is intended to ensure the rotational and translational positioning of the device, formed by two straight or curved segments that trace an angle at the sharp crest (α) and which is oriented along the longitudinal axis (YY′) of the semi-cylindrical base and which between them define, along the transverse axis (ZZ′) of the base, a semi-cylindrical cradle of radius (r′) that is at most equal to that (r) of the internal wall of the tube in the area of its orifice, with this latter being formed by a whistle-shaped notch made in the back of the tube, so that it constitutes a female part that comprises, in a manner similar to the male part of the device, two complementary segments that trace out an angle at the sharp crest (α1) that is identical to the angle at the aforementioned sharp crest (α) and oriented along the longitudinal axis (WW′) of the tube. The connection port may, in particular, may be an external connection, a tube or even a sensor.

Advantageously, the top of acute angle (α1) that is formed by segments of the notch in the tube, and consequently that of the acute angle (α) of the segments of the skirt-shaped part that acts as the male part of the device, are located on the assembly on the longitudinal axis (WW′) of the tube.

Advantageously, the angles at the top (α1 and α) in which are traced, respectively, the segments of the notch in the tube and the segments of the skirt-shaped part of the device are angles that merge with each other, and which are bisected by lines that are noticeably perpendicular with respect to the longitudinal axis (WW′) of the tube.

Advantageously, the segments of the notch in the tube and the complementary segments of the skirt-shaped part of the device, together make the shape of a V.

Advantageously, the segments of notch in the tube, as well as the complementary segments of the skirt-shaped part of the device, together make the shape of a semi-cylinder.

Advantageously, the segments of notch in the tube and the complementary segments of the skirt-shaped part of the device, together make a semi-spherical shape.

Advantageously, the segments of notch in the tube and the complementary segments of the skirt-shaped part of the device, together make the shape of a semi-ellipse.

Advantageously, the base of the foot of the device extends along its longitudinal axis (YY′) and along its transverse direction (ZZ′), so that it forms a saddle of dimensions and shape that partially enclose the tube when assembled.

Advantageously, the longitudinal lateral sides of the saddle formed by the base of the foot of the device extend beyond the transverse median plane (PP′) of the tube, so as to achieve elastic locking of the saddle when it is assembled onto the back of the tube and hold the assembly in place before final assembly by welding or gluing.

Advantageously, the materials that make up the device and the tube are plastic materials that make it possible to produce the device by molding and the tube by extrusion.

Advantageously, the base of the foot of the device is assembled onto the tube by welding or gluing through the application of an interface layer.

The present invention also concerns the characteristics that will become apparent from the following description, and which must be considered individually or in any of their possible technical combinations.

This description is given as a non-limiting example and will help with understanding how the invention can be produced by referring to the attached drawings, in which:

### BRIEF DESCRIPTION OF THE DRAWINGS

FIGS. 1 and 2 show a device and an associated tube before assembly, according to one example of an embodiment of the invention, respectively in an exploded perspective view and in a transverse cross-section view.

FIGS. 3 and 4 show the same components according to FIGS. 1 and 2, after assembly.

FIG. 5 shows, in a perspective view from below and in enlarged scale, a device according to the invention.

FIG. 6 shows, in a longitudinal cross-section view, the device-tube assembly according to line VI-VI in FIG. 2, before assembly.

FIG. 7 shows, in a transverse cross-section view, the device-tube assembly according to Figure VII-VII in line 6, before assembly.

FIG. 8 shows, in a longitudinal cross-section view, the device-tube assembly according to line VIII-VIII in FIG. 4, after assembly.

FIG. 9 shows, in a transverse cross-section view, the device-tube assembly according to line IX-IX in FIG. 8.

FIGS. 10 and 11 show, in a longitudinal cross-section view, the device-tube assembly after assembly, according to FIG. 8, whose final assembly by welding is performed, respectively, by vibration or by laser, indicated in bold lines.

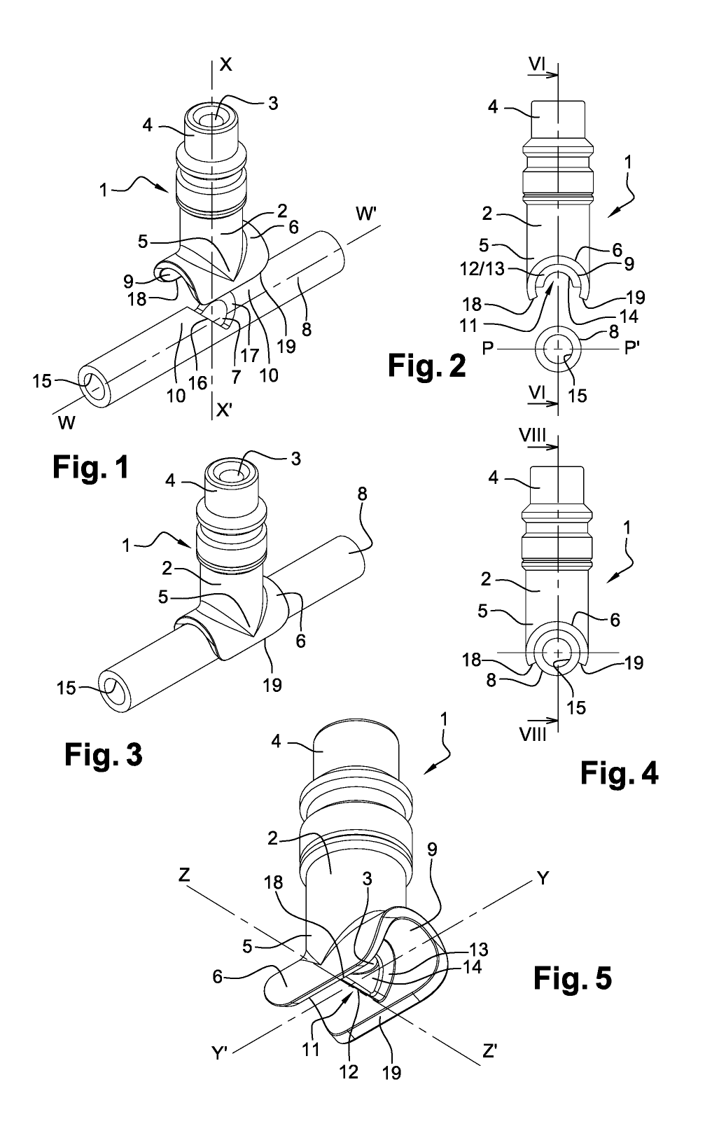

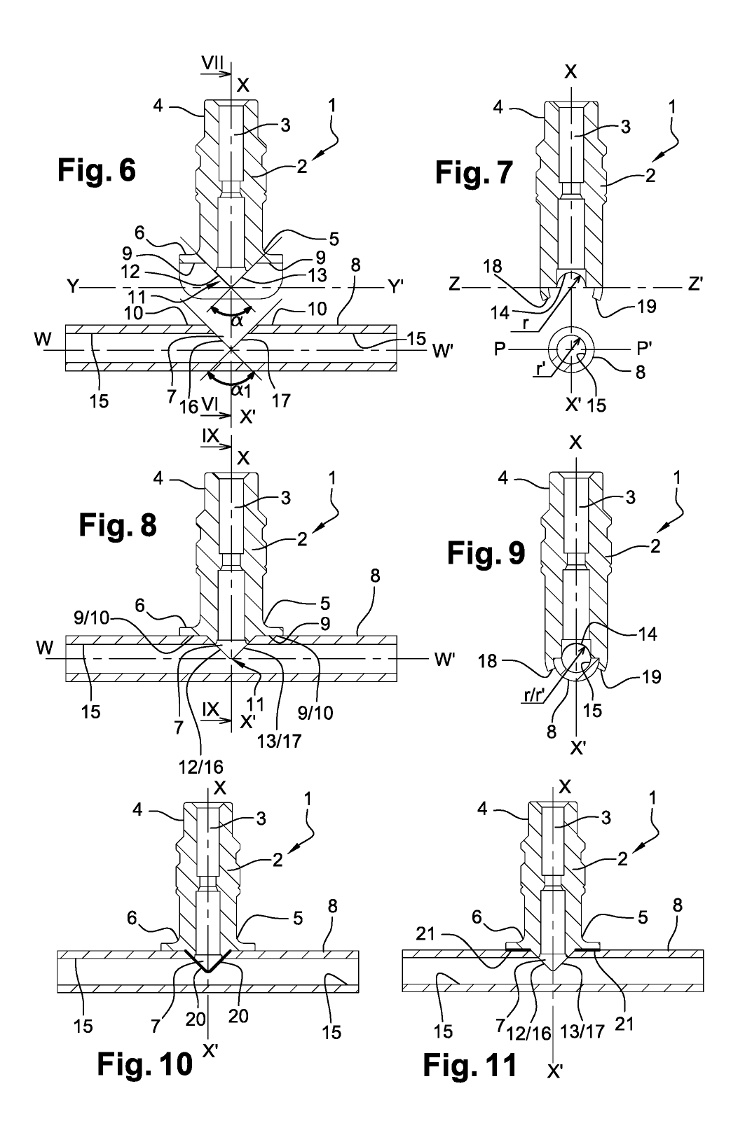

### DETAILED DESCRIPTION OF THE DRAWINGS

Fluid device 1, which is generally described in the figures, is, in a known manner, formed by a body 2 of injectable material and crossed axially by a conduit 3 whose head or front end 4 is designed to accommodate an external connection (not shown), and whose foot 5 into which the conduit 3 discharges is affixed by its base 6, that is largely perpendicular to axis XX′ of conduit 3, so that it can be located facing a communication orifice 7 that was made in the periphery of a tube 8 that is also made of an extrudable or injectable material, through the use of a welding carried out between, on the one hand, an inside part 9 of the base 6 of foot 5 of the fluid device 1, which has a semi-cylindrical curved surface 9 into which conduit 3 discharges and, on the other hand, a part corresponding to tube 10 located in the area of its orifice 7.

According to one example of an embodiment of the invention, the internal semi-cylindrical part 9 that forms the base 6 of the foot 5 of device 1 features, in relief, around the discharging conduit 3, a part in the shape of a skirt 11 that forms a male part that is intended to ensure the rotational and translational positioning of the device 1, formed by two straight or curved segments 12, 13 that trace an angle at the sharp crest a and which is oriented along the longitudinal axis YY′ of the semi-cylindrical base 6 and which together define 12, 13, along the transverse axis ZZ′ of the base 6, a semi-cylindrical cradle 14 of radius “r′” which is equal to the radius “r” of the internal wall 15 of the tube 8 in the area of its orifice 7, where this latter is formed by a whistle-shaped notch 7 made in the back of tube 8, that forms a female part that includes, in a manner similar to that for male part 11 of device 1, of two complementary segments 16, 17 that trace an angle at the sharp crest al that is identical to the angle at the aforementioned sharp crest a and oriented along the longitudinal axis WW′ of tube 8.

It should be noted that the top of acute angle α1 formed by segments 16, 17 of notch 7 in tube 8, and consequently that of acute angle α of segments 12, 13 of the skirt-shaped part 11 that constitutes the male part of the device, are located upon assembly on longitudinal axis WW′ of tube 8.

As can be seen in the figures, the angle at the crest a in which segments 16, 17 of the notch 7 in tube 8 are traced, and segments 12, 13 of the skirt-shaped part 11 of device 1 are right angles that merge with each other, and whose bisecting lines are perpendicular respectively to the longitudinal axis WW′ of tube 8 and to the longitudinal axis XX′ of conduit 3 of device 1. According to the manner of embodiment shown, segments 16, 17 of the notch 7 in tube 8 and the complementary segments 12, 13 of the skirt-shaped part 11 of device 1 together form the shape of a V.

Of course, these complementary segments 16, 17-12, 13 of notch 7 and of the skirt-shaped part 11 may be semi-cylindrical, semi-spherical, semi-elliptical, etc. in shape. According to another characteristic of the invention, base 6 of the foot 5 of device 1 extends along its longitudinal axis YY′ and along its transverse direction ZZ′, so that it forms a saddle of dimensions and shape that partially enclose tube 8 when it is assembled.

Preferably, the lateral longitudinal sides 18, 19 of the saddle formed by base 6 of the foot 5 of device 1 extend beyond the transverse median plane PP′ of tube 8, in such a way that, upon assembly, elastic locking of the saddle 6 occurs with the back of the tube 8 and keeps the assembly in place before final assembly by welding 20.

Advantageously, the materials that constitute device 1 and tube 8 are plastic materials that make it possible to produce the device by molding and the tube by extrusion.

As is shown in FIGS. 10 and 11, after assembly, the device 1-tube 8 assembly is permanently assembled by vibration welding 20 (FIG. 10), by laser welding 21, or even by gluing through the application of an interface layer.

The advantages relative to the invention are based on the fact that if the assembly of the device stays in place all by itself, it is because it is in the required angular, axial and radial positions, for its final assembly by welding.

Moreover, when it is designed in this way, the assembly area of the part in the shape of a V-shaped skirt at the base of the device that is designed to closely fit into a corresponding notch in the tube, makes it possible for it to breach any obstacle to fluid flow in the tube.

The invention also makes it possible to make a non-concentric perforation in a tube, for the purpose of attaching a sensor, shunt, valve, etc.

1. Device intended especially for a leakproof air-conditioning fluid circuit, of the type formed by a body made of injectable material and by a tube, with the said body being crossed axially by a conduit whose head or front end acts as a connecting port, and whose foot into which the conduit discharges is attached by its base, which is largely perpendicular to the axis (XX′) of the conduit, is placed facing a communication orifice that is made in the periphery of the tube made of injected or extruded material through the use of welding or gluing that is performed between, on the one hand, both the interior part of the base of the foot of the device which has a semi-cylindrical curved surface into which the conduit discharges and, on the other hand, a corresponding part of tube located in the area of its orifice, wherein the internal semi-cylindrical part that forms the base of the foot of the device features, in relief, around the discharging conduit, a part in the shape of a skirt that forms a male part that is intended to ensure the rotational and translational positioning of the device, formed by two straight or curved segments that trace an angle at the sharp crest (α) and which are oriented along the longitudinal axis (YY′) of the semi-cylindrical base and which together define, along the transverse axis (ZZ′) of the said base, a semi-cylindrical cradle of radius (r′) that is at most equal to that radius (r) of the internal wall of the tube in the area of its orifice, with this latter being formed by a whistle-shaped notch made in the back of the tube, that forms a female part that comprises, in a manner that is similar to the male part of the device, two complementary segments that trace an angle at the sharp crest (α1) that is identical to the angle at the aforementioned sharp crest (α) and oriented along the longitudinal axis (WW′) of the tube.

2. Device according to claim 1, wherein the top of acute angle (α1) that is formed by segments of the notch in the tube, and consequently that of the acute angle (α) of segments of the skirt-shaped part that acts as the male part of the device, which is located, upon assembly, on the longitudinal axis (WW′) of the tube.

3. Device according to claim 1, wherein the angles at the top (α1 and α) in which are traced, respectively, segments of the notch in the tube and segments of the skirt-shaped part of the device are angles that converge, and whose bisecting lines are noticeably perpendicular with respect to the longitudinal axis (WW′) of tube.

4. Device according to claim 1, wherein the segments of the notch in the tube and the complementary segments of the skirt-shaped part of the device together make the shape of a V.

5. Device according to claim 1, wherein the segments of the notch in the tube and the complementary segments of the skirt-shaped part of the device together make a semi-cylindrical shape.

6. Device according to claim 1, wherein the segments of the notch in the tube and the complementary segments of the skirt-shaped part of the device together make a semi-spherical shape.

7. Device according to claim 1, wherein the segments of the notch in the tube and the complementary segments of the skirt-shaped part of the device together make a semi-elliptical shape.

8. Device according to claim 1, wherein the base of the foot of the device extends along its longitudinal axis (YY′) and along its transversal direction (ZZ′), so that it forms a saddle of dimensions and shape that partially enclose the tube when it is assembled.

9. Device according to claim 8, wherein the longitudinal lateral sides of the saddle formed by the base of the foot of the device extend beyond the median transverse plane (PP′) of the tube, so that, upon assembly, there occurs an elastic locking of the saddle onto the back of the tube which holds the assembly in place before final assembly is performed by welding or gluing.

10. Device according to claim 1, wherein the materials comprising the device and the tube are plastic materials that make it possible to produce the device by molding and the tube by extrusion.

11. Device according to claim 1, wherein the base of the foot of the device is assembled onto the tube by welding or gluing through the application of an interface layer.
